(19) United States
(12) Patent Application Publication
(10) Pub. No.: US 2019/0127067 A1
(43) Pub. Date: May 2, 2019

(54) Autonomous aerial vehicle

(71) Applicant: Sunshine Aerial Systems, Inc., Grand Forks, ND (US)

(72) Inventors: Elena Parrello, Grand Forks, ND (US); Eva Adele Steger, Grand Forks, ND (US); Connor Bowley, Grand Forks, ND (US); Benjamin Jager, Grand Forks, ND (US)

(21) Appl. No.: 16/098,839

(22) PCT Filed: May 3, 2017
(86) PCT No.: PCT/US17/30757

§ 371 Date: Nov. 2, 2018

Related U.S. Application Data
(60) Provisional application No. 62/330,893, filed on May 3, 2016.

(51) Int. Cl. B64C 39/02; G08G 5/00; G01S 15/89; G05D 1/00; G05D 1/10

(52) U.S. Cl. CPC B64C 39/024; G08G 5/0069; G01S 15/89; G08G 5/0034; B64C 2201/123; G08G 5/0021; G05D 1/0088; G05D 1/101; B64C 2201/141; G08G 5/0013

(57) ABSTRACT

Autonomous aerial vehicles and methods of operating the same. An unmanned aerial vehicle in accordance with various embodiments may receive a defined flight path, at least a portion of which is underground. The vehicle may then autonomously travel along the defined flight path and gather imagery regarding its environment as it travels.

### CROSS REFERENCE TO RELATED APPLICATIONS

The present application claims the benefit of co-pending U.S. provisional application No. 62/330,893, filed on May 3, 2016, the entire disclosure of which is incorporated by reference as if set forth in its entirety herein.

### TECHNICAL FIELD

This invention generally relates to systems, devices, and methods for operating aerial vehicles and, more particularly but not exclusively, to systems, devices, and methods for operating aerial vehicles that navigate autonomously along a defined flight path.

### BACKGROUND

Unmanned aerial vehicles such as drone devices or the like have become increasingly popular over the past several years. These vehicles may perform search-and-rescue missions, monitor inventory at construction sites, gather intelligence regarding crops, monitor sporting events, or simply be used for entertainment and recreational purposes.

These vehicles are generally reliant on human operators for operation. For example, operators may have to control or otherwise instruct the vehicle when the vehicle is in flight. While autonomous vehicles may exist, they tend to rely on global positioning systems (GPS) to operate and navigate. This limits their effectiveness in underground environments, indoors, or in other areas where GPS operation is unavailable or ineffective.

A need exists, therefore, for unmanned aerial vehicles and methods of operating unmanned aerial vehicles that overcome these disadvantages.

### SUMMARY

This summary is provided to introduce a selection of concepts in a simplified form that are further described below in the Detailed Description section. This summary is not intended to identify or exclude key features or essential features of the claimed subject matter, nor is it intended to be used as an aid in determining the scope of the claimed subject matter.

In one aspect, embodiments relate to a method of operating an unmanned aerial vehicle. The method includes providing a vehicle comprising an optical flow sensor, a memory, and a processor configured to navigate the vehicle along a flight path utilizing input from the optical flow sensor; receiving the flight path for the vehicle; gathering vehicle position data via the optical flow sensor; processing the vehicle position data to identify a deviation from the received flight path; and altering the navigation of the vehicle to correct for the deviation, wherein the vehicle travels the received flight path without human intervention.

In one embodiment, at least a portion of the flight path is underground.

In one embodiment, the method further includes gathering, via the optical flow sensor, a distance measurement between the vehicle and an external obstacle as the vehicle is traveling along the flight path; determining, via the processor, whether the distance measurement exceeds a predetermined threshold; and altering, via the processor, the flight path of the vehicle to decrease the distance measurement.

In one embodiment, the method includes gathering, via the optical flow sensor, a distance measurement between the vehicle and an external obstacle as the vehicle is traveling along the flight path; determining, via the processor, whether the distance measurement is below a predetermined threshold; and altering, via the processor, the flight path of the vehicle to increase the distance measurement.

In one embodiment, the method further includes gathering imagery via at least one sensor device. In one embodiment, the method further includes transferring the imagery in substantially real time for viewing on a display. In one embodiment, the method further includes transferring the imagery after the vehicle completes the flightpath for viewing on a display. In one embodiment, the at least one sensor device includes an image gathering device and at least one ultrasonic transducer.

According to another aspect, embodiments relate to an unmanned aerial vehicle. The vehicle includes an optical flow sensor for gathering vehicle position data; a memory; and a processor executing instructions stored on the memory to: receive a flight path for the vehicle; navigate the vehicle along the flight path utilizing vehicle position data from the optical flow sensor, process the vehicle position data gathered by the optical flow sensor to identify a deviation from the received flight path as the vehicle travels the flight path, and alter the navigation of the vehicle to correct for the deviation, wherein the vehicle travels the received flight path without human intervention.

In one embodiment, at least a portion of the flight path is underground.

In one embodiment, the optical flow sensor is configured to gather a distance measurement between the vehicle and an external obstacle as the vehicle is traveling along the flight path, and the processor is further configured to determine that the distance measurement exceeds a predetermined threshold and alter the flight path of the vehicle to decrease the distance measurement.

In one embodiment, the optical flow sensor is configured to gather a distance measurement between the vehicle and an external obstacle as the vehicle is traveling along the flight path, and the processor is further configured to determine that the distance measurement is below a predetermined threshold and alter the flight path of the vehicle to increase the distance measurement.

In one embodiment, the vehicle further includes at least one sensor device for gathering imagery as the vehicle travels along the flight path. In one embodiment, the vehicle further includes a transceiver device for transferring the imagery in substantially real time for viewing on a display. In one embodiment, the vehicle includes a transceiver device for transferring the imagery after the vehicle completes the flight path for viewing on a display. In one embodiment, the at least one sensor device includes an image gathering device and at least one ultrasonic transducer.

According to yet another aspect, embodiments relate to a system for surveying underground environments. The system includes a computing device including an interface, a memory, and a processor executing instructions stored on the memory to configure the interface to enable an operator to define a flight path; and an unmanned aerial vehicle configured to travel along the flight path, wherein the vehicle includes an optical flow sensor for gathering vehicle position data; a vehicle memory; and a vehicle processor executing instructions stored on the vehicle memory to receive the defined flight path; navigate the vehicle along the flight path utilizing input from the optical flow sensor, process the vehicle position data gathered by the optical flow sensor to identify a deviation from the flight path as the vehicle travels along the flight path, and alter the navigation of the vehicle to correct for the deviation, wherein the vehicle travels the flight path without human intervention.

In one embodiment, at least a portion of the flight is underground.

In one embodiment, the vehicle further includes at least one sensor device for gather imagery as the vehicle travels along the flight path, the at least one sensor device including an image gathering device and at least one ultrasonic transducer.

In one embodiment, the vehicle includes a transceiver device for transferring the imagery in substantially real time to the interface or transferring the imagery after the vehicle completes the flight path.

### BRIEF DESCRIPTION OF DRAWINGS

Non-limiting and non-exhaustive embodiments of the invention are described with reference to the following figures, wherein like reference numerals refer to like parts throughout the various views unless otherwise specified.

FIG. 1 illustrates an unmanned aerial vehicle in accordance with one embodiment;

FIG. 2 illustrates the software map and data connections for operating an unmanned aerial vehicle in accordance with one embodiment;

FIG. 3 illustrates a map of an underground environment in accordance with one embodiment;

FIG. 4 illustrates a defined flight path on the map of FIG. 3 in accordance with one embodiment;

FIG. 5 illustrates defined regions of interest on the map of FIG. 3 in accordance with one embodiment;

FIG. 6 illustrates directional axes with respect to a vehicle in accordance with one embodiment;

FIG. 7 depicts various agents of the control module of FIG. 2 for executing an autopilot program in accordance with one embodiment;

FIG. 8 illustrates a display for reviewing imagery gathered by a vehicle in accordance with one embodiment; and

FIG. 9 depicts a flowchart of a method of operating an unmanned aerial vehicle in accordance with one embodiment.

### DETAILED DESCRIPTION

Various embodiments are described more fully below with reference to the accompanying drawings, which form a part hereof, and which show specific exemplary embodiments. However, the concepts of the present disclosure may be implemented in many different forms and should not be construed as limited to the embodiments set forth herein; rather, these embodiments are provided as part of a thorough and complete disclosure, to fully convey the scope of the concepts, techniques and implementations of the present disclosure to those skilled in the art. Embodiments may be practiced as methods, systems or devices. Accordingly, embodiments may take the form of a hardware implementation, an entirely software implementation or an implementation combining software and hardware aspects. The following detailed description is, therefore, not to be taken in a limiting sense.

Reference in the specification to “one embodiment” or to “an embodiment” means that a particular feature, structure, or characteristic described in connection with the embodiments is included in at least one example implementation or technique in accordance with the present disclosure. The appearances of the phrase “in one embodiment” in various places in the specification are not necessarily all referring to the same embodiment.

Some portions of the description that follow are presented in terms of symbolic representations of operations on non-transient signals stored within a computer memory. These descriptions and representations are used by those skilled in the data processing arts to most effectively convey the substance of their work to others skilled in the art. Such operations typically require physical manipulations of physical quantities. Usually, though not necessarily, these quantities take the form of electrical, magnetic or optical signals capable of being stored, transferred, combined, compared and otherwise manipulated. It is convenient at times, principally for reasons of common usage, to refer to these signals as bits, values, elements, symbols, characters, terms, numbers, or the like. Furthermore, it is also convenient at times, to refer to certain arrangements of steps requiring physical manipulations of physical quantities as modules or code devices, without loss of generality.

However, all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical quantities within the computer system memories or registers or other such information storage, transmission or display devices. Portions of the present disclosure include processes and instructions that may be embodied in software, firmware or hardware, and when embodied in software, may be downloaded to reside on and be operated from different platforms used by a variety of operating systems.

The present disclosure also relates to an apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions, and each may be coupled to a computer system bus. Furthermore, the computers referred to in the specification may include a single processor or may be architectures employing multiple processor designs for increased computing capability.

The processes and displays presented herein are not inherently related to any particular computer or other apparatus. Various general-purpose systems may also be used with programs in accordance with the teachings herein, or it may prove convenient to construct more specialized apparatus to perform one or more method steps. The structure for a variety of these systems is discussed in the description below. In addition, any particular programming language that is sufficient for achieving the techniques and implementations of the present disclosure may be used. A variety of programming languages may be used to implement the present disclosure as discussed herein.

In addition, the language used in the specification has been principally selected for readability and instructional purposes and may not have been selected to delineate or circumscribe the disclosed subject matter. Accordingly, the present disclosure is intended to be illustrative, and not limiting, of the scope of the concepts discussed herein.

Various embodiments described herein provide an autonomous aerial vehicle that overcomes the previously discussed disadvantages of existing vehicles and techniques. The autonomous aerial vehicle(s) (hereinafter “vehicle(s)”) in accordance with various embodiments may be instructed to travel along a predetermined flight path. The vehicle in various embodiments may include a memory, processor, and an optical flow sensor including an image gathering device to assist the vehicle in traveling along the predetermined flight path.

The vehicle processor may process the data gathered by the optical flow sensor. If the processor detects, based on the gathered imagery, a deviation from the flight path, the processor may adjust the navigation of the vehicle to correct for the deviation.

The vehicle may also include at least one ultrasonic transducer to detect the distance from the vehicle to the ground (i.e., the height of the vehicle during flight). The vehicle may also include ultrasonic sensor devices positioned about the vehicle to detect the distance between the vehicle and various obstacles such as walls.

As the vehicle travels along the flight path the vehicle may gather imagery (e.g., video, pictures, etc.) of the environment using additional image gathering devices. Once the vehicle completes the flight path, the gathered imagery may be viewed by an operator. Additionally or alternatively the vehicle may transmit the imagery to an interface for viewing by an operator in at least substantially real time using a wired or wireless interface.

The vehicle may be a drone-type device or the like. One such vehicle may be a quadcopter device including four propellers that are each driven by a separate motor.

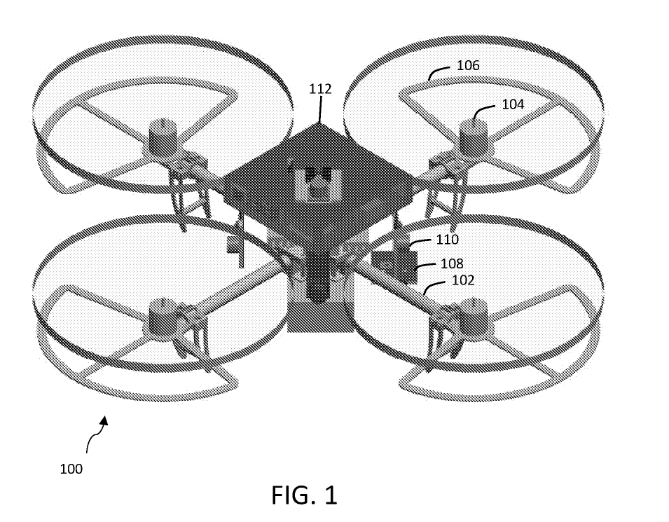

FIG. 1 illustrates a vehicle 100 in accordance with one embodiment. In this particular embodiment, the vehicle 100 may be a quadcopter vehicle. The vehicle 100 may include a frame 102 supporting four motors 104 that each drive a propeller (not shown) that are each protected by a guard 106. Each motor 104 may be controlled by a corresponding electronic speed controller (not shown).

The vehicle 100 may also include sensor plates 108 for mounting one or more sensor devices 110 thereon. The vehicle 100 may further store any required on-board processing devices and sensor devices in a compartment 112.

In use, the vehicle 100 may receive a flight path defined by an operator. For example, a city employee may define a flight path through an underground sewer system. The operator may define this flight path via a user interface that executes a flight application to present a graphical user interface for interaction by the operator.

The flight path may be uploaded to a USB drive or the equivalent by operating the user interface. The USB drive may then be removed from the user interface and then connected to the vehicle. The flight path may be downloaded from the USB drive to the vehicle's processor for execution. Additionally or alternatively, data regarding the flight path may be communicated wirelessly to the vehicle.

Once the vehicle has instructions or data regarding the defined flight path, the vehicle may autonomously travel along the flight path. The vehicle may execute an autopilot program that uses data gathered by various sensors to navigate along the flight path.

As the vehicle travels along the flight path, the vehicle may gather imagery of the environment in which the vehicle is traveling. For example, the imagery may be gathered to detect any damage to a sewer system.

The imagery may be stored on a USB drive or the equivalent connected with the vehicle and, after the vehicle completes the flight path, the USB drive may be removed from the vehicle, connected to a user interface, and then an operator may view the gathered imagery. Additionally or alternatively, the imagery may be communicated to the user interface for viewing in substantially real time.

Features of various embodiments described herein therefore enable employees or other personnel such as sewer inspectors, cave explorers, underground transit employees, construction workers, or other types of underground workers (hereinafter “operator”) to perform their jobs in better conditions. This saves time, resources, and promotes safety as employees are relieved from working underground.

The frame 102 may be a commercial-off-the-shelf frame with or without modifications. The frame 102 may be made of any suitable material such as carbon fiber and/or aluminum. The exact type of material may vary and may depend on the particular embodiment. For example, an operator may consider the durability and weight of the frame 102 to determine the appropriate material(s).

The motors 104 may be any suitable device that can receive input from an electronic speed controller (ESC) to power a propeller. In one embodiment, for example, each motor 104 may require a 40 amp ESC for control. The exact type, power, and size of the motors 104 may vary depending on the particular requirements of the vehicle and the task at hand.

The propellers are preferably made of a lightweight material such as plastic. In one embodiment, the propeller may be ten inches long. The exact size of the propellers may vary and may depend on the power of the motors 104 and the size and weight of the vehicle 100 itself. The propeller guards 106 may be mounted on the underside of the propellers and may be 3D printed ABS plastic, for example.

The compartment 112 may be fabricated out of carbon fiber or any other suitable material and may store any required processing and hardware components. The compartment 112 may be mounted on the frame 102 via screws, for example. The exact configuration or material of the compartment 112 may vary as long as it can store the processing and hardware components required to operate the vehicle 100.

Although not shown in FIG. 1, the vehicle 100 may include a power source such as a battery or the like to provide power to the various vehicle components. The power source may be secured to the vehicle 100 and may be placed in a battery cage. The battery cage may be made out of aluminum or any suitable material as long as it can secure the battery in place. Other embodiments may use fuel cells, broadcast power, etc., in lieu of a battery.

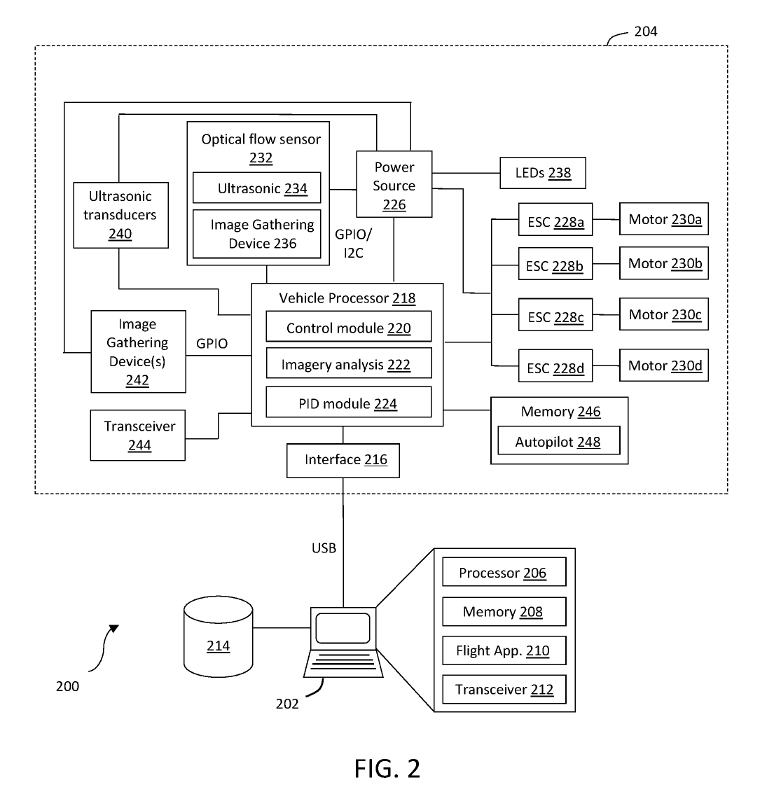

FIG. 2 illustrates the software map 200 and data connections for operating an unmanned aerial vehicle in accordance with one embodiment. As shown in FIG. 2, the map 200 includes a user interface 202 in operable communication with a vehicle 204 such as the vehicle 100 of FIG. 1.

An operator such as a city employee may operate the user interface 202 to define a flight path for the vehicle 204. The user interface 202 may be configured as, for example and without limitation, a PC, a tablet, a mobile device (e.g., smart phone), a laptop, a smartwatch, or the like. The user interface 202 may execute or otherwise include a processor 206, memory 208, a flight application 210, and a transceiver 212, and may further be in communication with one or more databases 214.

The processor 206 may be any hardware device capable of receiving input regarding commands or instructions from the operator. The processor 206 may be a microprocessor, a field programmable gate array (FPGA), an application-specific integrated circuit (ASIC), or other similar devices. In some embodiments, such as those relying on one or more ASICs, the functionality described as being provided in part via software may instead be configured into the design of the ASICs and, as such, the associated software may be omitted. The processor 206 may be configured as part of the user interface 202 (e.g., a laptop) or may be located at some remote location.

The memory 208 may be L1, L2, L3 cache or RAM memory configurations. The memory 208 may include non-volatile memory such as flash memory, EPROM, EEPROM, ROM, and PROM, or volatile memory such as static or dynamic RAM, as discussed above. The exact configuration and type of memory 208 may of course vary as long as instructions for operating the processor 206 and the flight application 210 can be executed.

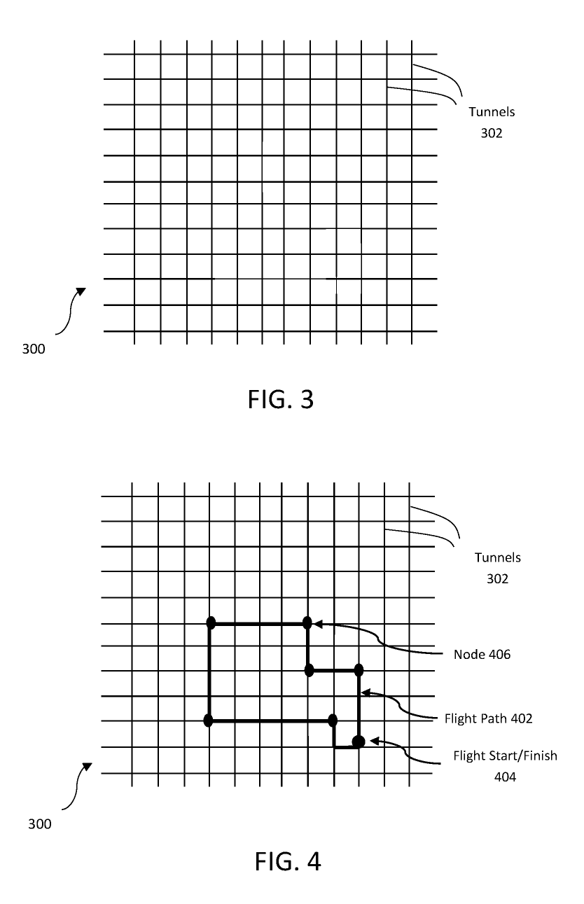

The flight application 210 enables an operator to define a flight path via the user interface 202. For example, the flight application 210 may present a map such as the map 300 of FIG. 3 that represents a series of underground tunnels 302. This map 300 and the tunnels 302 may correspond to a sewer system of a certain city region.

The map 300 may be previously loaded as part of the flight application 210 and/or may be stored in a database 214 for retrieval. Once an operator has selected an appropriate map, the operator may then define a flight path by selecting or otherwise highlighting certain portions of the map 300.

For example, an operator may select certain tunnels via a touch screen device or via a mouse-and-cursor mechanism. FIG. 4 illustrates the map 300 of FIG. 3 with a defined flight path 402 (indicated by bold lines overlaid on certain portions of the map 300). This defined flight path 402 may pass through certain portions of the sewer system in which the operator believes there may be damage.

Also shown in FIG. 4 is a start and finish location 404. The vehicle may start at location 404, travel along the flight path 402, and then return to the location 404. The flight path 402 may include a series of individual segments separated by nodes 406 that represent a point in the flight path 402 in which the vehicle must do something besides travel forward. It is also noted that the start and end locations need not be the same.

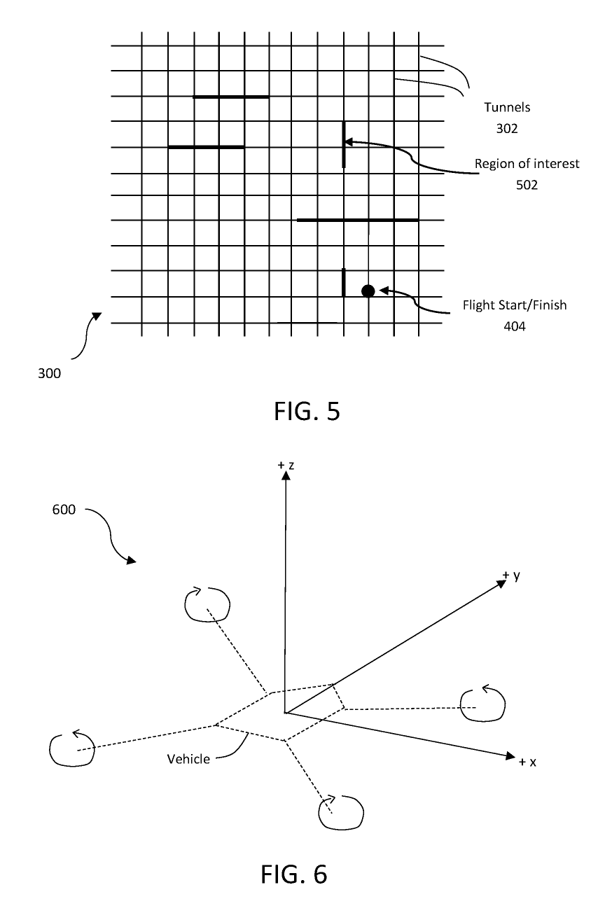

In addition to or in lieu of defining a closed path as in FIG. 4 (i.e., a path that starts and finishes at the same location), an operator may define discrete regions for the vehicle to traverse. For example, FIG. 5 illustrates the map of FIGS. 3 and 4 and selected regions of interest 502. In this particular embodiment, an operator may only be interested in having the vehicle visit certain locations that may or may not adjoin each other. In operation, the vehicle may then travel to and visit each specified location, and the processor 204 and/or onboard processing devices may determine the shortest path through the map to visit all of the locations.

In one embodiment, the defined flight path may be loaded onto a USB drive operably connected to the user interface 202. Once the flight path is loaded onto the USB drive, the USB drive may be removed from the interface 202. Then, the USB drive may be connected to the vehicle 204 such that the flight path is uploaded to the vehicle 204. The flight path file may be parsed before take off and verified to ensure it does not contain any non-valid commands. Additionally or alternatively, the transceiver 212 may wirelessly communicate data regarding a defined flight path to the vehicle 204.

Flight paths may be saved and stored in the database 214 or some other medium for reuse. This may save time as an operator isn't required to always define a flight path from scratch. This may be especially useful if an operator wants to conduct repetitive, periodic surveillances of an area, share a defined flight plan with another operator, or maintain a record of a flight plan executed on a particular date.

The transceiver 212 may enable communication with another interface at a remote location. For example, the transceiver 212 may receive commands or other types of data from vehicles in the field as well as other interfaces that relate to operation of a vehicle.

The vehicle 204 may include a vehicle interface 216 for receiving the USB drive storing the defined flight path(s) and for communicating the flight paths to the vehicle processor 218.

The vehicle processor 218 may be any hardware device capable of receiving input such as the defined flight path. The vehicle processor 218 may be a microprocessor, a field programmable gate array (FPGA), an application-specific integrated circuit (ASIC), or other similar devices. In some embodiments, such as those relying on one or more ASICs, the functionality described as being provided in part via software may instead be configured into the design of the ASICs and, as such, the associated software may be omitted. The vehicle processor 218 may include a control module 220, an imagery analysis module 222, and a proportional integral derivative (PID) module 224.

The control module 220 may be in communication with the vehicle interface 216 and be configured to receive data regarding the flight path. The control module 220 may be configured as or otherwise include a Raspberry Pi® device, a KK2.1 control board, an Arducopter control board, or the like. The control module 220 may perform any required processing steps to at least navigate the vehicle 204 along a flight path. The control module 220 may also include or otherwise be configured with an inertial measurement unit (IMU) to gather data regarding the vehicle's movement.

The imagery analysis module 222 may be executed by the processor 218 to analyze imagery gathered by the various sensor devices, discussed below. For example, depending on the embodiment and the types of sensors used, the imagery analysis module 222 may execute various computer vision techniques and procedures to extract meaningful information regarding the environment from the sensor data.

The PID module 224 may control output to the motors by, for example, calculating an error between some desired value and the current value. This error and the derivative and integral thereof is then multiplied by one or more constants, the weighted sum of which is used to supply the output given to the ESCs 228a-d.

A power source 226 may supply power to the vehicle processor 218 as well as the other components of the vehicle 204. The power source 226 may include one or more battery devices, for example.

Output from the vehicle processor 218 may be used to control each ESC 228a-d. In one embodiment, the ESCs 228a-d are 40A ESCs that are each connected to a motor 230a-d, respectively.

The optical flow sensor(s) 232 may be a PX4FLOW device which is designed for quadcopters. In this particular embodiment, the optical flow sensor(s) 232 may include an ultrasonic transducer 234 and an image gathering device 236 such as a camera.

In some embodiments, the optical flow sensor(s) 232 may be placed on the underside of the vehicle 204 and oriented downward. In these embodiments, the optical flow sensor 232 may measure movement in the plane perpendicular to the direction the optical flow sensor 232 is facing and therefore detect the flight direction of the vehicle 204. Specifically, the image gathering device 236 may gather data regarding the vehicle's movement using conventional optical flow techniques, and the ultrasonic transducer 234 may measure the distance from the ground.

The ultrasonic transducer 234 may use pulse width modulation to determine the distance between the vehicle 204 and the ground during flight. A PWM pin on the sensor may be connected via a GPIO pin on the control module 220. In use, these ultrasonic transducer 234 may be driven by the control module 220 to produce periodic ultrasonic pulses, e.g., every 20 milliseconds. The time between the transmission of the pulse and the subsequent measurement of the reflected pulse by the transducer 234 may be used to determine the height of the drone, i.e., assuming that the speed of sound in air is, e.g., 1,125 ft/sec.

The optical flow sensor 232 may be connected to the vehicle processor 218 by the I2C protocol that also utilizes the GPIO pins on the vehicle processor 218 (e.g., on a Raspberry Pi device). In some embodiments, the optical flow sensor 232 may send data packets over the I2C protocol that contain values for the velocity of the vehicle 204 in the “x” direction and velocity in the “y” direction. These directions with respect to the vehicle are shown in the coordinate system 600 of FIG. 6. The data packets may also include data such as the distance from the vehicle 204 to the ground. The vehicle 204 may also include a series of light emitting diodes 238 to provide illumination as the vehicle 204 travels along the flight path.

In some embodiments, the optical flow sensor 232 may be placed on the side of the vehicle 204 or on the top of the vehicle 204. Or, multiple optical flow sensors 232 may be positioned at various locations on the vehicle 204 for added redundancy. Accordingly, the optical flow sensor(s) 232 measure velocity in the x and y directions or in the x and z directions. It is also noted that the optical flow sensors 232 of various embodiments do not require an ultrasonic transducer configured therewith, as there may be several separate ultrasonic transducers (discussed below) configured with the vehicle 204. Although not shown, the vehicle 204 may also include one or more microwave sensors used for obstacle avoidance.

The vehicle 204 may also include a plurality of ultrasonic transducers 240 placed on the sides of the vehicle 204 to determine the distance between the respective vehicle side and an obstacle (e.g., a wall). Accordingly, the ultrasonic transducers 240 may detect the distance from walls in all directions about the vehicle 204. These ultrasonic transducers 240 may operate similarly to the ultrasonic transducer 234.

The vehicle 204 may further include a plurality of image gathering devices 242 for gathering imagery of the environment as the vehicle 204 travels the flight path. These image gathering devices 242 may be positioned about the vehicle 204 to gather a 360 degree view about the vehicle. In some embodiments, the image gathering devices 242 may be PiCam® camera devices, which take 1080p videos at 30 fps and 720p videos at 60 fps. The image gathering devices 242 may include other types of camera devices such as LIDAR, stereo cameras, infrared cameras, or the like. The exact configuration of the image gathering devices 242 may vary to facilitate the gathering of the required imagery as the vehicle 204 travels along the flight path. Each image gathering device 242 may also be configured with an ultrasonic transducer 240.

The vehicle 204 may also include a transceiver device 244 to enable communication with an operator or other interested party. The transceiver device 244 may, for example, communicate the gathered imagery to the user interface 202 for viewing by an operator.

The vehicle 204 may include onboard memory 246 storing instructions for execution by the vehicle processor 218. These instructions may include instructions for an autopilot program 248, discussed below.

Once the flight path is loaded onto or otherwise communicated to the vehicle 204, the vehicle may execute instructions for the onboard autopilot program 248. In the context of the present application, the term “autopilot program” may refer to the code that is used to decide what movement the vehicle 204 should take while traveling along the flight path. The autopilot program 248 may be executed by the various components of the processor 218.

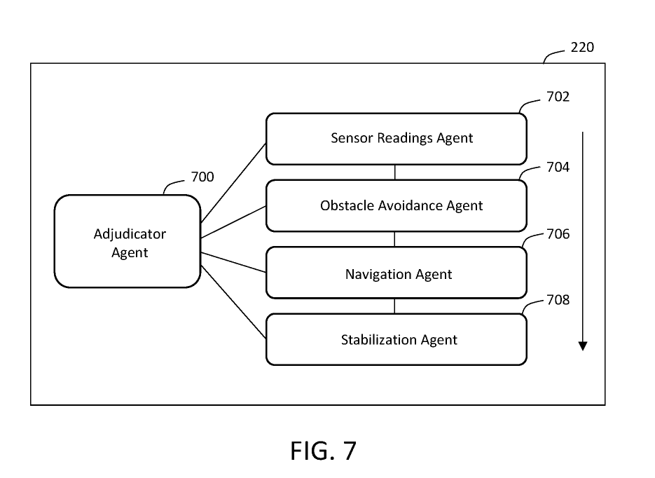

FIG. 7 depicts several agents of the control module 218 that operate in parallel to execute the autopilot program 248 in accordance with one embodiment. These agents may include an adjudicator agent 700, a sensor readings agent 702, an obstacle avoidance agent 704, a navigation agent 706, and a stabilization agent 708. The adjudicator agent 700 may act as an adjudicator of the various agents to prioritize the outputs and commands from the various agents.

The output of each of these agents feeds into the next agent. The higher the agent is in the flow (excluding the sensor readings agent 702), the more authority the step has which is managed by the adjudicator agent 700. For example, any actions or commands from the obstacle avoidance agent 704 can override actions or commands from the navigation agent 706, and commands from the navigation agent 706 or the obstacle avoidance agent 704 can override any commands from the stabilization agent 708.

The sensor readings agent 702 may receive the data obtained from the optical flow sensor 232 as well as the other ultrasonic transducers 240. In operation, two parallel arrays of data may be fed into the control module 220 and more particularly into the sensor readings agent 702. These arrays are referred to as axes and axesDir. The axes array contains the values that specify the desired change in distance between the vehicle 204 and the nearest identified obstacle along a particular axis, and the axesDir array specifies limits for these values.

The data may then be communicated to the obstacle avoidance agent 704. The obstacle avoidance agent 704 ensures the vehicle 204 does not collide with obstacles identified by the ultrasonic transducers 240 and/or other types of sensor devices such as microwave sensors. The obstacle avoidance agent 704 considers the data gathered by these sensors in all directions/sides of the vehicle 204 (up, down, front back, left, right) and performs one of three actions based on the distance measured to some obstacle in each direction.

First, if the distance between the vehicle 204 and an obstacle (e.g., a wall) exceeds a predetermined “safe” distance, the obstacle avoidance agent 704 will not enter a value in the element of axes that corresponds to that particular vehicle side. Instead, the obstacle avoidance agent 704 may enter an “x” into the corresponding element of axesDir to indicate that any value is permissible. In other words, this does not prohibit or otherwise limit the vehicle's movement in that particular direction.

The second scenario occurs when the distance between a side of the vehicle 204 and an external obstacle is less than a “caution” distance. In this scenario, the obstacle avoidance agent 704 may enter a “0” value into axes and a ‘<’ or ‘>’ into axesDir. Whether a ‘<’ or a ‘>’ is used may depend on the direction in which the obstacle is found with respect to a coordinate system such as the system 600 of FIG. 6. A ‘<’ value in axesDir would allow the navigation agent 706 or the stabilization agent 708 to enter a value that is less than the current value at that element of axes (assuming that the value is acceptable to the obstacle avoidance agent 704), but not a value that is greater than the measured value. This prevents the vehicle 204 from moving any closer to the detected obstacle. However, this alone does not cause the vehicle 204 to move away from the obstacle. Should the navigation agent 706 or stabilization agent 708 agent issue commands to move the vehicle 204 away from the obstacle, they are free to do so.

The third scenario occurs when the distance between a side of the vehicle 204 and an external obstacle is less than a “danger” distance. In this scenario, the obstacle avoidance agent 704 may enter a value that is proportional to the inverse of the measured distance into axes. The obstacle avoidance agent 704 may also enter a ‘<’ or a ‘>’ into axesDir, depending on the direction of the obstacle.

If the distances between both sides of the vehicle 204 and an external obstacle are less than the “caution” or “danger” distance, then the values calculated by each side for axes are summed and a ‘=’ value may be written into axesDir. The ‘=’ value prevents the navigation agent 706 and the stabilization agent 708 from subsequently changing the value. Once this is done for all sides, the navigation agent 706 may carry out the next steps of the autopilot program 248.

The navigation agent 706 enables the vehicle 204 to travel from a start point to an end point and ensures the vehicle stays on the flight path. A flight path for the vehicle 204 may be a single, straight path, or may involve a series of turns. The latter class of flight path may be decomposed into a series of straight-line segments over which the navigation agent 706 outputs commands to guide the vehicle 204. For each segment, the navigation agent 706 initializes the vehicle's position as [ 0, 0, current_height] and specifies a desired location that is initialized to [0, distance_forward, current_height].

The navigation agent 706 compares the current location with the desired location and, if they are different, the control module 220 may instruct the PID module 224 to implement a PID control loop to move the vehicle in the desired direction. If the vehicle is at the desired location on an axis, the PID module 224 simply does not change anything and a value of “0” will be assigned in axes for that particular axis.

To allow for good video quality, the navigation agent 706 may limit the vehicle's speed to approximately 1 foot/second per axis. The speed measurements with respect to movement along the x axis and the y axis may be based on data from the ultrasonic transducers 240 and the speed in the z direction may be calculated from the change in height from the ground.

In summary, the navigation agent 706 may compare the vehicle's current location with the desired location along each axis. If they are different, the control module 220 may in some embodiments instruct the PID module 224 to achieve a speed of 1 foot/sec in the desired direction.

The stabilization agent 708 is responsible for the final part of the autopilot program 248. The commands for stabilization in the x and y directions may be outputted from the navigation agent 706. Rotational stabilization about the z-axis may be handled by the PID module 224 to move the vehicle 204 to the appropriate height. However, in some embodiments the functionality of the navigation agent 706 and the stabilization agent 708 may be combined.

Referring back to FIG. 2, the flight application 210 may enable an operator to view imagery gathered by the image gathering devices 242 in real time and/or after the vehicle has completed the flight path. In one embodiment, the flight application 210 may implement a depth-first graph traversal technique to display the route.

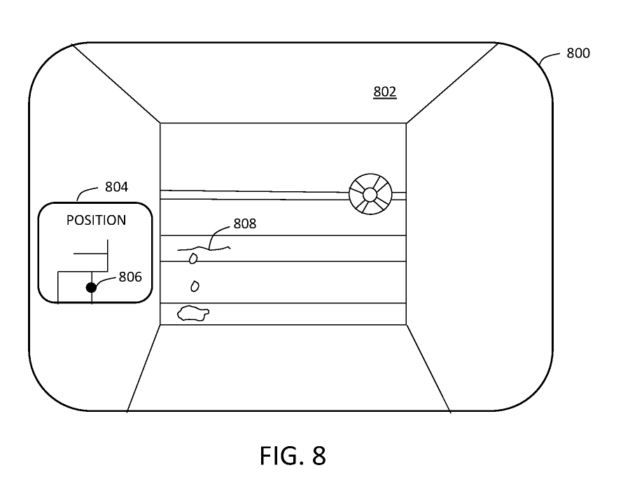

As the operator is viewing the gathered imagery, the flight application 210 may cause the user interface 202 to present a graphical representation of where the vehicle is with respect the flight path. For example, FIG. 8 presents a display 800 that may be presented on the user interface 202. The display 800 shows imagery 802 gathered by a vehicle such as the vehicle 204 of FIG. 2. In this particular embodiment, the vehicle may be traveling through a sewer system.

The display 800 may also present a position display 804 (e.g., as a picture-in-picture view or as a split-screen view) that shows the position of the vehicle 806 with respect to a map. Accordingly, an operator may monitor the position of the vehicle as they review the imagery gathered by the vehicle. If damage 808 is detected, the operator may quickly refer to the position display 804 to determine where exactly the damage has occurred.

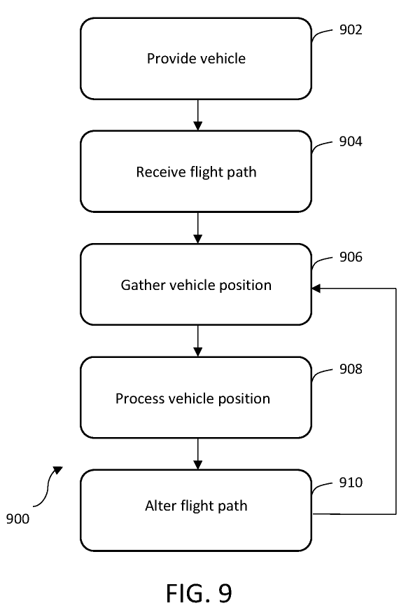

FIG. 9 depicts a flowchart of a method 900 of operating an autonomous aerial vehicle in accordance with one embodiment. Step 902 involves providing an autonomous aerial vehicle. The vehicle may be similar to the vehicles 100 and 204 of FIGS. 1 and 2, respectively, and include a processor, memory, and an optical flow sensor.

Step 904 involves receiving a flight path for the vehicle. The flight path may be previously defined by an operator.

Step 906 involves gathering vehicle position. Data regarding vehicle position may be gathered by the various sensor devices of FIG. 2, for example. This may include input from an optical flow sensor.

Step 908 involves processing the vehicle position to identify a deviation from the received flight path. For example, the optical flow sensor may gather a distance measurement between the vehicle and an external obstacle as the vehicle travels along the flight path. The processor may then determine whether the distance measurement exceeds a predetermined threshold. Or, in another embodiment, the processor may determine whether the distance measurement is below a predetermined threshold.

Step 910 involves altering flight path via the processor. For example, if the distance measurement exceeds a predetermine threshold, the processor may alter the flight path to decrease the distance measurement. Or, if the distance measurement is below the predetermined threshold, the processor may alter the flight path to increase the measurement.

The methods, systems, and devices discussed above are examples. Various configurations may omit, substitute, or add various procedures or components as appropriate. For instance, in alternative configurations, the methods may be performed in an order different from that described, and that various steps may be added, omitted, or combined. Also, features described with respect to certain configurations may be combined in various other configurations. Different aspects and elements of the configurations may be combined in a similar manner. Also, technology evolves and, thus, many of the elements are examples and do not limit the scope of the disclosure or claims.

Embodiments of the present disclosure, for example, are described above with reference to block diagrams and/or operational illustrations of methods, systems, and computer program products according to embodiments of the present disclosure. The functions/acts noted in the blocks may occur out of the order as shown in any flowchart. For example, two blocks shown in succession may in fact be executed substantially concurrent or the blocks may sometimes be executed in the reverse order, depending upon the functionality/acts involved. Additionally, or alternatively, not all of the blocks shown in any flowchart need to be performed and/or executed. For example, if a given flowchart has five blocks containing functions/acts, it may be the case that only three of the five blocks are performed and/or executed. In this example, any of the three of the five blocks may be performed and/or executed.

A statement that a value exceeds (or is more than) a first threshold value is equivalent to a statement that the value meets or exceeds a second threshold value that is slightly greater than the first threshold value, e.g., the second threshold value being one value higher than the first threshold value in the resolution of a relevant system. A statement that a value is less than (or is within) a first threshold value is equivalent to a statement that the value is less than or equal to a second threshold value that is slightly lower than the first threshold value, e.g., the second threshold value being one value lower than the first threshold value in the resolution of the relevant system.

Specific details are given in the description to provide a thorough understanding of example configurations (including implementations). However, configurations may be practiced without these specific details. For example, well-known circuits, processes, algorithms, structures, and techniques have been shown without unnecessary detail in order to avoid obscuring the configurations. This description provides example configurations only, and does not limit the scope, applicability, or configurations of the claims. Rather, the preceding description of the configurations will provide those skilled in the art with an enabling description for implementing described techniques. Various changes may be made in the function and arrangement of elements without departing from the spirit or scope of the disclosure.

Having described several example configurations, various modifications, alternative constructions, and equivalents may be used without departing from the spirit of the disclosure. For example, the above elements may be components of a larger system, wherein other rules may take precedence over or otherwise modify the application of various implementations or techniques of the present disclosure. Also, a number of steps may be undertaken before, during, or after the above elements are considered.

Having been provided with the description and illustration of the present application, one skilled in the art may envision variations, modifications, and alternate embodiments falling within the general inventive concept discussed in this application that do not depart from the scope of the following claims.

What is claimed is:

1. A method of operating an unmanned aerial vehicle, the method comprising:
providing a vehicle comprising an optical flow sensor, a memory, and a processor configured to navigate the vehicle along a flight path utilizing input from the optical flow sensor;
receiving the flight path for the vehicle;
gathering vehicle position data via the optical flow sensor;
processing the vehicle position data to identify a deviation from the received flight path; and
altering the navigation of the vehicle to correct for the deviation,
wherein the vehicle travels the received flight path without human intervention.

2. The method of claim 1, wherein at least a portion of the flight path is underground.

3. The method of claim 1, further comprising:
gathering, via the optical flow sensor, a distance measurement between the vehicle and an external obstacle as the vehicle is traveling along the flight path;
determining, via the processor, whether the distance measurement exceeds a predetermined threshold; and
altering, via the processor, the flight path of the vehicle to decrease the distance measurement.

4. The method of claim 1, further comprising:
gathering, via the optical flow sensor, a distance measurement between the vehicle and an external obstacle as the vehicle is traveling along the flight path;
determining, via the processor, whether the distance measurement is below a predetermined threshold; and
altering, via the processor, the flight path of the vehicle to increase the distance measurement.

5. The method of claim 1, further comprising gathering imagery via at least one sensor device.

6. The method of claim 5, further comprising transferring the imagery in substantially real time for viewing on a display.

7. The method of claim 5, further comprising transferring the imagery after the vehicle completes the flight path for viewing on a display.

8. The method of claim 5, wherein the at least one sensor device includes an image gathering device and at least one ultrasonic transducer.

9. An unmanned aerial vehicle comprising:
an optical flow sensor for gathering vehicle position data;
a memory; and
a processor executing instructions stored on the memory to:
receive a flight path for the vehicle;
navigate the vehicle along the flight path utilizing vehicle position data from the optical flow sensor,
process the vehicle position data gathered by the optical flow sensor to identify a deviation from the received flight path as the vehicle travels the flight path, and
alter the navigation of the vehicle to correct for the deviation, wherein the vehicle travels the received flight path without human intervention.

10. The vehicle of claim 9, wherein at least a portion of the flight path is underground.

11. The vehicle of claim 9, wherein the optical flow sensor is configured to gather a distance measurement between the vehicle and an external obstacle as the vehicle is traveling along the flight path, and the processor is further configured to determine that the distance measurement exceeds a predetermined threshold and alter the flight path of the vehicle to decrease the distance measurement.

12. The vehicle of claim 9, wherein the optical flow sensor is configured to gather a distance measurement between the vehicle and an external obstacle as the vehicle is traveling along the flight path, and the processor is further configured to determine that the distance measurement is below a predetermined threshold and alter the flight path of the vehicle to increase the distance measurement.

13. The vehicle of claim 9, further comprising at least one sensor device for gathering imagery as the vehicle travels along the flight path.

14. The vehicle of claim 13, further comprising a transceiver device for transferring the imagery in substantially real time for viewing on a display.

15. The vehicle of claim 13, further comprising a transceiver device for transferring the imagery after the vehicle completes the flight path for viewing on a display.

16. The vehicle of claim 13, wherein the at least one sensor device includes an image gathering device and at least one ultrasonic transducer.

17. A system for surveying underground environments, the system comprising:
a computing device including:
an interface,
a memory, and
a processor executing instructions stored on the memory to configure the interface to enable an operator to define a flight path; and
an unmanned aerial vehicle configured to travel along the flight path, wherein the vehicle includes:
an optical flow sensor for gathering vehicle position data;
a vehicle memory; and
a vehicle processor executing instructions stored on the vehicle memory to:
receive the defined flight path;
navigate the vehicle along the flight path utilizing input from the optical flow sensor,
process the vehicle position data gathered by the optical flow sensor to identify a deviation from the flight path as the vehicle travels along the flight path, and
alter the navigation of the vehicle to correct for the deviation, wherein the vehicle travels the flight path without human intervention.

18. The system of claim 17, wherein at least a portion of the flight path is underground.

19. The system of claim 17, wherein the vehicle further comprises at least one sensor device for gathering imagery as the vehicle travels along the flight path, the at least one sensor device including an image gathering device and at least one ultrasonic transducer.

20. The system of claim 17, wherein the vehicle includes a transceiver device for transferring the imagery in substantially real time to the interface or transferring the imagery after the vehicle completes the flight path.
